(19) United States
(12) Patent Application Publication
(10) Pub. No.: US 2002/0157010 A1
(43) Pub. Date: Oct. 24, 2002

(54) Secure system and method for updating a protected partition of a hard drive

(75) Inventors: Richard Alan Dayan, Wake Forest, NC (US); Joseph Wayne Freeman, Raleigh, NC (US); William Fred Keown JR., Raleigh, NC (US); Randall Scott Spingfield, Chapel Hill, NC (US)

Correspondence Address: IBM Corporation, Personal and Printing Systems Group, Dept. 9CCA/Bldg. 002-2, P.O. Box 12195, Research Triangle Park, NC, 27709, US

(73) Assignee: International Business Machines Corporation, Armonk, NY (US)

(21) Appl. No.: 09/841,503

(22) Filed: Apr. 24, 2001

(51) Int. Cl. G06F 12/14

(52) U.S. Cl. 713/191

(57) ABSTRACT

A computer system includes a hard drive having a protected partition, which is locked during operation of an initialization program following power on in the system. A trusted server generates an update partition file, which is transferred to the computer system to be stored in non-volatile storage. During subsequent initialization, before the protected partition is locked, encrypted information available only to the server and the computer system is used to verify that the file was generated by the server, and the file is used to update information within the protected partition.

### CROSS-REFERENCE TO A RELATED APPLICATION

### BACKGROUND INFORMATION

1. Field of Invention

This invention relates to a method for writing to a hard drive partition that is otherwise protected from writing, and, in particular, to a secure method allowing a remote trusted system to write information to such a hard drive partition.

2. Background Art

In a number of computer systems, the system hard drive includes a partition which is protected, or “locked” so that data and instructions cannot be written into the partition by the computer system after the system is booted. While such a partition is not locked when power is turned on in the system, it is locked during the execution of an initialization routine, such as POST (Power-On Self Test), following power-on. Since the partition is thus locked before the operating system is loaded, neither the operating program nor an application program operating under the operating system can open the partition to write data or instructions. Also, the user cannot open the partition to write data or instructions.

Such a protected partition is used, for example to store special diagnostic routines, which can be run later by the user or by a technical support engineer to verify the operation of a portion of the computer system. While locking the partition prevents access to the protected partition to modify the data and instructions contained therein, a means is otherwise provided to load the routines stored within the partition so that they may be executed within the processor of the computer system. These routines are stored in the protected partition to avoid vulnerability to attack from a virus or corruption from system software or the user.

A protected file partition of this type, known by the acronym “PARTIES” (Protected Area Run Time Interface Extension Services, is described in a document being developed as an ANSI standard T13 D1367. This proposed standard describes a BIOS (Basic Input Output System) firmware layer that may be used to both place and execute system diagnostics on a protected area of the system hard drive, with one of the purposes of the diagnostics being to accurately determine whether the hard drive is functioning correctly. The firmware layer may also be used to run DOS-based rescue utilities once the drive has been shown to be working by the diagnostics stored in the protected partition. Thus, the computer system is shipped from the manufacturer with embedded diagnostic and rescue capabilities that are known to be reliable, and that cannot easily become corrupted.

This proposed standard also describes a method providing for loading the diagnostics to run, based on the use of a conventional SET MAX command. The area protected by a SET MAX ADDRESS command remains bootable even when the system is unable to boot the primary operating system. According to the proposed standard, the diagnostics are loaded after BIOS finds the start of the reserved area boot code and issues a SET MAX ADDRESS command, with the reserved area boot code being emulated as the bootable primary floppy disk drive.

Potential problems with protected hard drive partitions of this type arise from the fact that the instructions and data stored therein cannot be modified in a secure manner. Such a modification may be needed to correct an error found in the routines after the computer system is shipped, to update the routines corresponding to changes in the configuration of an individual computer system, or to introduce new routines into the partition if more efficient or effective diagnostic procedures are found. Thus, what is needed is a secure way to gain access to the protected partition for writing data and instructions.

A number of techniques of encryption and decryption have been developed to provide secure communications between computer systems. Of particular significance are the development of asymmetrical encryption algorithms, in which the key used to decrypt a message cannot be reasonably determined from the key used to encrypt the message, and the development of public key cryptography, in which a first computer system stores a public key, which is made available to a second system sending a message to the first computer system, and a private key, which is held within the first computer system itself. The message is encrypted by the second system using the public key of the first system, is transmitted in encrypted form to the first system, and is decrypted within the first system using the private key of the first system. While the private key decrypts a message encrypted by the public key, due to asymmetry of the algorithm, the private key cannot be deduced from the public key.

Digital signatures provide assurance that a message has been sent from a known computer system and that the message has not been altered in transmission. A computer sending a message creates a digital signature by using a conventional hash function reducing the message to a short message digest. The message digest is then encrypted or signed with the private key of the sending computer system, forming a digital signature. When another computer receives the message and the digital signature, it performs the same hash function on the message as the sending system. The digital signature received is “signed” or decrypted using the public key of the sending system. If the message has not been altered, the resulting message digest is the same as the message digest contained in the digital signature; otherwise, the message has been altered and is therefore rejected by the receiving system. Since the public key of the sending computer system is widely available, it is readily available to the receiving computer system for use in decrypting the digital signature. Furthermore, since the private key of the sending computer is held in secret, decrypting the digital signature with the public key of the sending computer to form the proper message digest proves both that the original message digest was encrypted with the private key of the sending system and that the identity of the sending system has been established.

Using a digital signature in this way does not provide for secrecy. The message is sent in a clear, unencrypted form. When secrecy is also required, another encryption technique is used. For example, both the message and the digital signature are encrypted with the public key of the receiving system. Then, since the message and digital signature can only be decrypted with the private key of the receiving system, which is held in secret, transmission can occur without a risk of surreptitious decryption by a third party. The receiving system decrypts the message to learn its content, and then processes the digital signature to verify the sending system.

The use of hash codes or digests to determine whether information has been corrupted is also described in U.S. Pat. No. 5,537,540, which describes a system which verifies the integrity of installed software on the computer system.

What is needed is a system and method applying encryption, decryption, and digital signature techniques to the problem of updating a number of remote computer systems in a secure manner.

U.S. Pat. No. 6,092,161 describes a method and apparatus for controlling access to write to a boot partition in a hard drive when a computer system running with a Microsoft WINDOWS operating system is running in the Supervised Mode. This mode, which is used for virus protection, makes the boot partition “read only.” However, WINDOWS, while not being strictly selfmodifying, requires that certain files located within the WINDOWS directory can be written to. Accordingly, the invention of U.S. Pat. No. 6,092,161 provides a method of controlling access to and modification of information stored on a storage medium forming part of a computer system comprising: dividing information stored on the storage medium into a plurality of non-overlapping partitions including a boot partition and at least one general partition, characterized by: designating at least one of said partitions a Write Many Recoverable (WMR) partition wherein, in use, if a write command is issued to overwrite any resident information stored in a/the WMR partition by updating, information by updating is written on the storage medium in a location other than where the resident information is stored and a (virtual) pointer to the updated information is set up/kept so that the updated information can be accessed, as required during a remainder of a session. Thus a partition can be updated, but only by copying the new information to a temporary new partition and providing a pointer to the new partition. When the session using the modified partition is completed, the temporary partition is deleted. What is needed is a method for permanently updating information in the protected partition in a secure manner.

U.S. Pat. No. 5,787,491 describes a method and apparatus for creating a new partition in a hard disk drive of a computer system and installing software, such as system software, into the new partition. A diskette is read for a unique diskette signature which, if present, indicates that the diskette contains software to be installed in a new partition. However, what is needed is a method using a signature to verify that the data to be recorded in a partition has indeed been transferred from a trusted system, such as a server performing security functions for the computer system. Furthermore, what is needed is a method allowing for the updating of information stored in a protected partition.

U.S. Pat. No. 6,108,759 describes methods and systems for copying, moving, and resizing disk partitions that contain advanced file systems, without addressing the writing of information to a protected partition.

A Japanese patent, JP63175955 describes a method for providing password protection to a special protection area within a fixed disk having plural partitions and to data on an associated diskette, with a registered user being able to update the data. What is needed is a secure method allowing a trusted system, such as a particular server providing security functions for the computing system, to update such data.

A number of other examples of patents and articles describe methods for selectively blocking and allowing access to certain stored data or routines for use of the data or routines while not considering the problem of changing data written to a protected area. For example, U.S. Pat. No. 5,809,230 describes an access control program including a plurality of program components for intercepting interrupt service calls, together with a boot control program to prevent a boot program stored on media within the diskette drive of a computer from acquiring control of the system during initialization. In another such example, U.S. Pat. No. 5,805,880 describes a utility routine which accesses a protected computer system component by making a call to a coprocessor that performs a desired function to avoid security measures imposed by an operating system. Other such examples are found in the IBM Technical Disclosure Bulletin, Vol. 36, No. 04, April 1993, in an article entitled “Supervisor Password Access to System Partition on Initial Microprogram Load Machines,” and Vol. 39, No. 11, November 1996, in an article entitled “Password Protection of Separate Hard Disk Partitions.”

### SUMMARY OF THE INVENTION

In accordance with a first version of the present invention, a method is provided for updating a protected partition within a hard drive of a computing system. The method includes starting execution of an initialization program in a processor within the computing system in response to turning on electrical power within the computing system, determining that an update partition file is stored in nonvolatile storage within the computing system for subsequently updating the protected partition, then writing a portion of the update partition file to the protected partition, and then locking the protected partition to prevent further modification of information stored therewithin.

The update partition file is generated within a trusted server and transferred to the client system. Preferably, the update partition file includes at least one encrypted element that is used by the initialization program executing in the computing system to verify that the update partition file was indeed generated by the trusted server.

In a preferred version of the invention, the update partition file includes a number of entries that are independently used to modify data within the protected partition. An encrypted element is associated with each entry is generated within the server by appending a version of a setup password to the entry, by applying a hash algorithm to the result to form a message digest, and by then encrypting the message digest with its cryptographic private key.

The initialization program executing in the computing system then generates a first version of the message digest by appending its setup password to the entry and by applying the same hash algorithm to the result. The initialization program also decrypts the encrypted element to form a second version of the message digest using the public key of the sending server. If the first and second versions are identical, and if space is available within the protected partition, the initialization program then uses the entry to update the data within the protected partition.

### BRIEF DESCRIPTION OF THE DRAWINGS

FIG. 1 is a block diagram of an interconnected system, including a computer system and a server, configured in accordance with the present invention;

FIG. 2 is a pictorial view of an update partition file stored within the computer system of FIG. 1 to change the contents of a protected partition within the computer system;

FIG. 3 is a pictorial view of a header element within the file of FIG. 2;

FIG. 4 is a pictorial view of an entry element within the file of FIG. 2;

FIG. 5 is a flow chart of a subroutine executing within the server of FIG. 1 to generate the update partition file of FIG. 2 for subsequent transmission to the computer system of FIG. 1;

FIG. 6 is a flow chart of processes occurring within the computer system of FIG. 1 during the execution of an initialization routine according to the present invention following power on of the computer system, with FIG. 6 being divided between an upper portion identified as FIG. 6A and a lower portion identified as FIG. 6B; and

FIG. 7 is a flow chart of processes occurring within the computer system of FIG. 1 during the execution of a signature authentication subroutine called by the initialization routine of FIG. 6.

### DESCRIPTION OF THE INVENTION

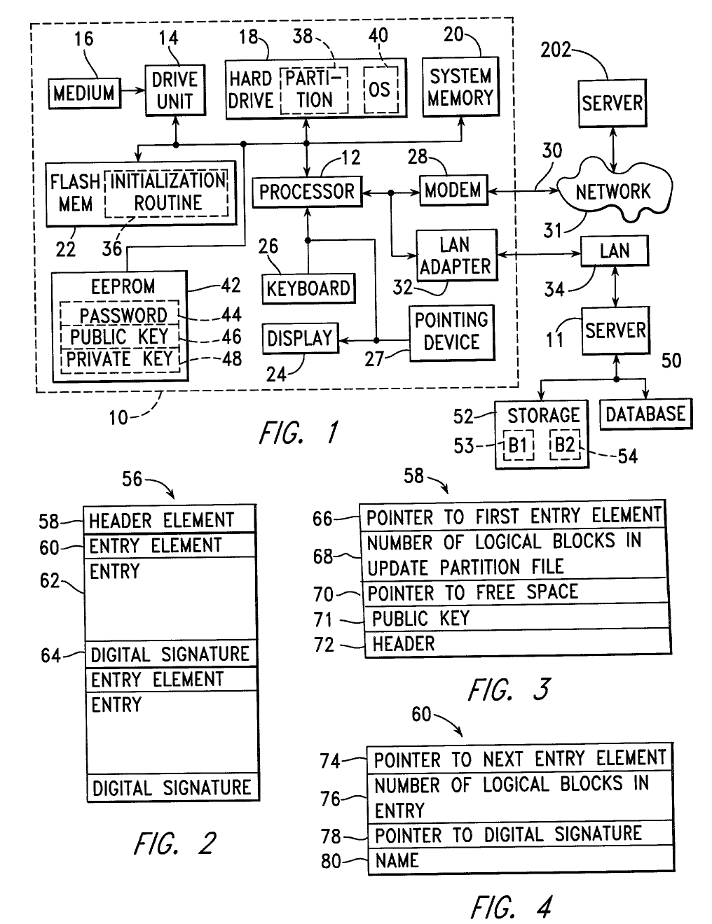

FIG. 1 is a block diagram of an interconnected system, including a computer system 10 and a server 11, configured in accordance with the present invention. The computer system 10 includes a processor 12, a drive unit 14 for reading a removable medium 16, which may be a floppy disk or a compact disk, a hard drive 18, a system memory 20, a read-only memory (ROM) or a flash memory 22, a display unit 24, and user input devices, such as a keyboard 26, and a pointing device 27. Preferably, the computer system 10 additionally includes communications means for accessing external data, such a modem 28 connected by a telephone line 30 to a network 31, such as the Internet and/or a LAN adapter 32 connected to a LAN (Local Area Network) 34. The computer system 10 may also include a number of other conventional elements (not shown), such as interface circuits, buses, and peripheral components.

The computer system 10 also includes an initialization routine 36, stored in non-volatile storage, such as the flash memory 22, as shown in the example of FIG. 1, which is accessed for execution within the processor 12 after system power on. The initialization routine 36 may alternatively or additionally be stored on the hard drive 18 and loaded into system memory 20 for execution within the processor 12 after system power on. The initialization routine 36 preferably includes a number of conventional diagnostic subroutines, commonly called POST subroutines, together with instructions causing a partition 38 within the hard drive 18 to be locked, preventing access for reading or writing instructions and data within the partition 38. In accordance with the present invention, the initialization routine 36 additionally includes instructions causing information to be written within the partition 38 after predetermined security procedures have occurred, but before the partition 38 is locked. Following execution of the initialization routine 36, an operating system 40 is loaded into the system memory 20 from the hard drive 18 for execution within the processor 12.

The computer system 10 also includes non-volatile storage of a form that can be programmed or written to under certain circumstances, such as an electrically erasable programmable read only memory (EEPROM) 42, which holds security-related information, such as a setup password 44, a cryptographic public key 46, and a cryptographic private key 48. The EEPROM 42 may also be used as secure storage in association with an additional processor (not shown), in which cryptographic processes are carried out.

In accordance with a first version of the present invention, the server 11 provides for certain technical and security-related processes within the computer system 10, and generally for a number of additional computer systems 10, also connected to the server 11 over the LAN 34. These processes include, for example, setting the original configurations of the computer systems 10 and updating the contents of the protected partition 38, using the setup password(s) 44 of the computer systems 10, which is also stored within a database 50 accessed by the server 11. Thus, the various computer systems 10 act as clients of the server 11 during the process of setting up and changing the configuration of the systems 10, while the server 11 acts as a trusted server for making such changes. In this regard, the server 11, LAN 34, and a number of computer systems 10 are typically operated by an organization that originally configured the computer systems 10 for use. In particular, the server 11 is used to update the contents of the protected partition 38 within the hard drive 18 of the computer system 10 as required. The server 10 also has access to storage 52, including a first buffer 53 and a second buffer 54, both of which are used in a process of preparing information to send to the system(s) 10 to update the protected partition 38 therein.

FIGS. 2-4 are pictorial views of an update partition file 56 stored within the computer system 10 to change the contents of a protected partition 38 within the hard drive 18, with FIG. 2 showing the format of the file 56, with FIG. 3 showing the format of a header element 58 of file 56, and with FIG. 4 showing the format of an entry element 60 of the file 56.

Referring to FIGS. 1-4, the update partition file 56 includes one or more entries 62, each of which is a block of information, including executable instructions and/or data to be copied into the protected partition 38. The information in each entry 62 may be used to replace corresponding information stored within the protected partition 38, or it may be appended to the information stored within the partition 38 if there is enough available space. Multiple entries, if present, are to be stored in different locations within the protected partition 38. Each entry 62 is associated with a corresponding entry element 60, preceding the entry 62, and with a corresponding digital signature 64, following the entry 62.

The header element 58 includes a pointer 66 to the first entry element 60, a number 68 describing the quantity of logical blocks of the update partition file itself, a pointer 70 to free space beyond the file 56, the public key 71 of the server 11, and descriptive header information 72. Each entry element 60 includes a pointer to the next entry element 74, which points to free space beyond the file 56 if the entry element 60 is the last in the file 56, a number 76 describing the quantity of logical blocks in the entry 62, a pointer 78 to the associated digital signature 64, and a name 80 describing the entry 62.

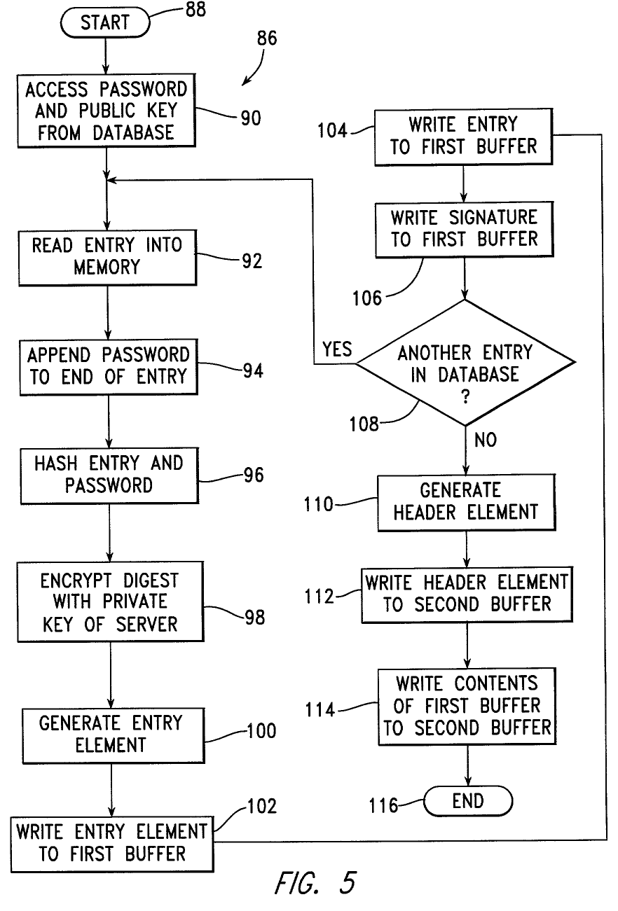

FIG. 5 is a flow chart of a subroutine 86 executing within the server 11 to generate the update partition file 56 to modify the protected partition 38 within the computer system 10 of FIG. 1, according to the contents of one or more entries 62 stored within the database 50 of the server 11. After this subroutine 86 is started in step 88, the setup password 44 and the public key 46 of the computer system 10 are accessed, in step 90, within the database 50 of the server 11. As previously described in reference to FIG. 1, the database 50 stores the setup password 44 of the system 10 because the server 11 is operated by the organization that set the configuration of the computer system 10. Now, the knowledge of the password is used to produce an update partition file 56 which will subsequently be accepted by the initialization routine 36 executing within the computer system 10 for updating the protected partition file 38. The database 50 also stores the public key 46 of the computer system 10, either because of a previous involvement of the server 11 in the process of setting the configuration of the computer system 10 or because the public key 46 is widely available.

Next, in step 92, an entry 62 is read from the database 50 into the storage 52 of the server 11. Then, in step 94, the setup password 44 of the system 10 is appended to the end of the entry 62 within the storage 52. In step 96, the entry 62 and the setup password 44 are hashed together to form a message digest, using a conventional algorithm, such as the SHA-1 hash algorithm. Then, in step 98, the message digest formed in step 96 is signed using the private key of the server 11. This process forms a conventional digital signature that is subsequently used to verify that the system sending the message is indeed the server 11.

Next, in step 100, the entry element 60 for the entry 62 is generated to include the data described above in reference to FIG. 4. If the entry is to be used to perform an update to data within the protected partition 38, the data matches a target entry in the protected partition 38. Next, in steps 102-106, the data associated with the entry 62 is assembled within the first buffer 53 of the server 11. First, the entry element generated in step 100 is written to the first buffer 53 in step 102. Next, the entry read into storage 52 in step 92 is written to the first buffer 53 in step 104. Next, the digital signature generated in step 98 is written to the first buffer 53 in step 106.

Then, in step 108, a determination is made of whether there is another entry 62 in the database 50. If there is another entry 62, the subroutine 86 returns to step 92 to read the next entry 62 into memory. Then, steps 94 through 108 are repeated for each entry 62 until entry elements 60, entries 62 and digital signatures 64 are appended to one another for each of the entries 62. When these processes have been completed for all entries 62, as determined in step 108, the subroutine 86 proceeds to step 110, in which the header element 58 is generated to include the data described above in reference to FIG. 3. Then, in step 112, the header element generated in step 110 is written to the second buffer 54. Next, in step 114, the contents of the first buffer 53 are written to the second buffer 54. Then, in step 116, the subroutine 86 ends, with the data to be used to update the partition 38 stored in the format discussed above in referenced to FIG. 2.

Continuing to refer to FIGS. 1 and 2, following the execution of subroutine 86, the second buffer 54 holds data in a form in which it is ready for transmission to the computer system 10. Using conventional processes for communications over a LAN, the server 11 establishes communications with the computer system 10 and transmits the update partition file 56 now stored in the second buffer 54 to the computer system 10. The file 56 is preferably stored at a predetermined location within the hard drive 18 of the computer system 10, outside the protected partition 38, where the file 56 will subsequently be found by an initialization routine 36 executing within the computer system 10. Also, a flag bit is set at a predetermined location within the hard file 56 to provide an indication that an update partition file 56 is available for loading into the protected partition 38.

Thus, in accordance with a preferred version of the invention, the entries 62 are sent in a clear, unencrypted form, since they do need to be held secret. The setup password 44, which does need to be held secret, is not itself transmitted, but is used, appended to the entry 62 in the generation, using a hash algorithm, of a message digest. The message digest is then signed using the private key of the server 11, forming a digital signature 64 and further encrypting the message digest. Redundant means are provided to determine subsequently that the transmission has occurred from the server 11, and not from another system being surreptitiously used to provide false data, in that the server has used its private key, which is held in secret, in the process of forming a digital signature 64, and in that the server has used the setup password 44 of the computer system 10, which is also held in secret, in generating the message digest, from which the digital signature 64 is formed.

Also in accordance with a preferred version of the invention, the computer system 10 is provided with means for modifying the contents of the protected partition 38 either when the flag bit is set to indicate the presence of an update partition file 56 stored within the hard drive 18 as described above, or when the system user indicates that he wants to make an update. Such an indication by the user must be made with the correct setup password 44 being typed on the keyboard 26 at power-on time. When power is turned on to the computer system 10, the protected partition 38 is not locked, and the initialization routine 36 is started. At a predetermined point in the execution of the initialization routine 36, the protected partition is locked, unless the user has previously provided the correct setup password. The processes associated with determining whether an update partition file 56 is present and for loading modifications from such a file to the protected partition 38 also occur before this partition 38 is locked by the initialization routine 36.

If the user determines that he wants to change the setup information stored in the protected partition 38, he may type the setup password 44 instead of a more-frequently used power-on password to start the system after turning the computer system 10 on. Alternately, he may depress a predetermined key sequence during early operation of the initialization routine 36 to cause the display of a screen providing for an input of the setup password 44.

On the other hand, the installation of an update partition file 56 transmitted from the server 11 may be transparent to the user, with the file 56 being stored in the hard drive 18 without his knowledge, and with the file 56 being used to perform the update the next time the computer system 10 is turned on.

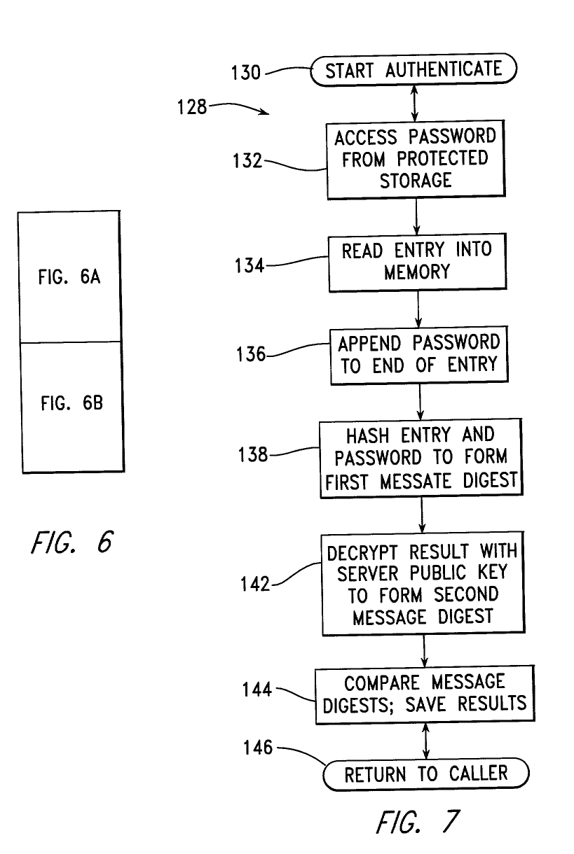

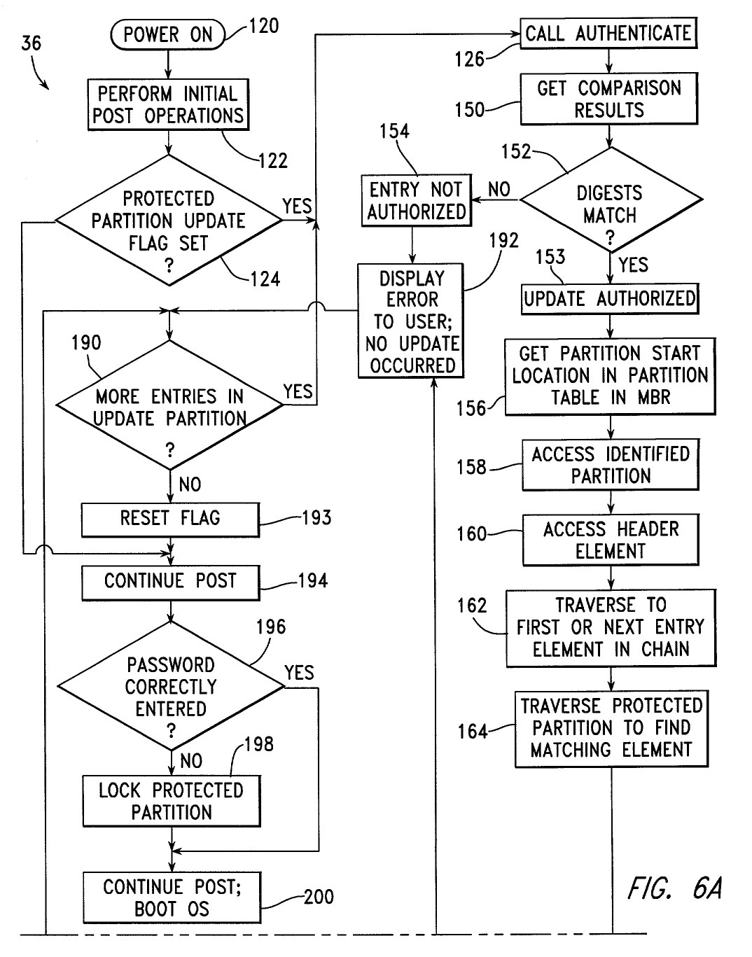

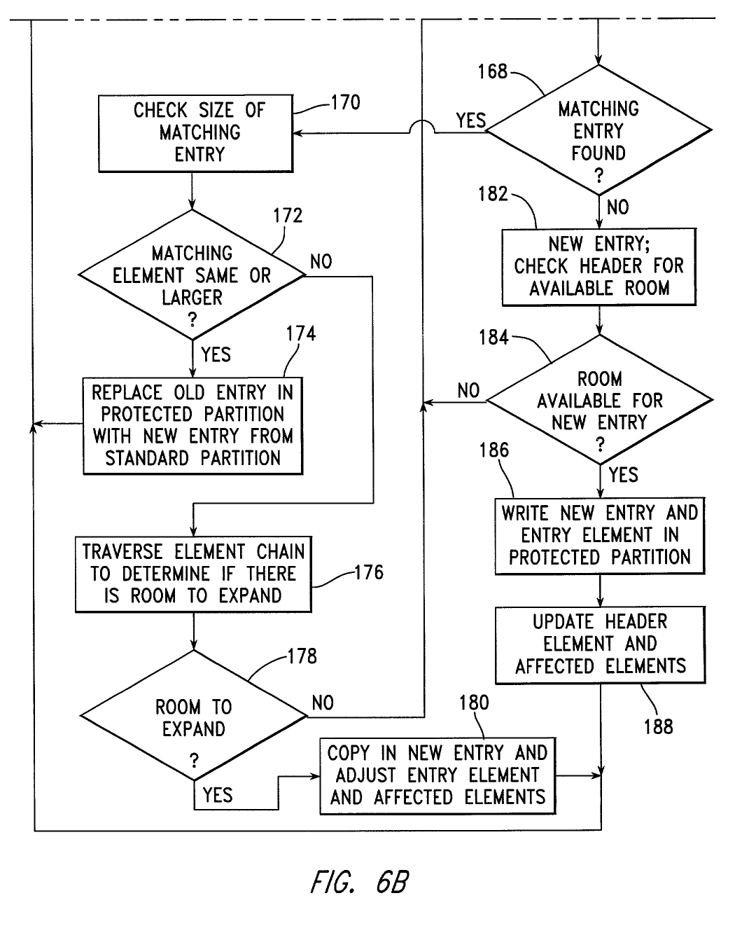

FIG. 6 is a flow chart of processes occurring within the computer system 10 during execution of the initialization routine 36 within the processor 12 following power-on within the computer system 10. FIG. 6 is divided into an upper portion labeled as FIG. 6A, and a lower portion, labeled as FIG. 6B.

Referring to FIGS. 1, 2, and 6, after the power to the computer system 10 is turned on in step 120, the initialization routine 36 proceeds to step 122, in which a number of Power-On Self Test (POST) operations are carried out, testing various devices within the system 10. Next, in step 124, a determination is made of whether the flag has been set as described above to indicate that an update partition file 56 is stored within the hard drive 18. If such a flag has been set, the initialization routine 36 calls an AUTHENTICATE subroutine in step 126 to authenticate the update partition file 56.

FIG. 7 is a flow chart of processes occurring during the execution of the AUTHENTICATE subroutine 128 after this subroutine is called by the initialization routine 36. After this subroutine 128 is started in step 130, the startup password 44 is accessed from secure storage in step 132. Next, in step 134, the first or next entry 62, forming a portion of the update partition file 56 stored in the hard drive 18 is read into system memory 20. In step 136, the password accessed in step 132 is appended to the entry 62 in the system memory 20. In step 138, the conventional hash algorithm, which has been previously used by the server 11 in step 96 of FIG. 5, is used to produce a first version of the message digest. Next, in step 142, the digital signature 64 forming a part of the update partition file 56 is decrypted, or signed, using the public key 71 of the server 11. Since this digital signature has been previously encrypted using the private key of the server 11, the result of step 142 is a second version of the message digest. In step 144 the first and second versions of the message digest are compared. If they are the same, the message must have been sent from the server 11, first because the public key 71 of the server 11 was successfully used in step 142 to perform a successful decryption, indicating that the data had previously been encrypted, or signed, using the private key of the server 11, and second because both versions of the message digest had been formed using the setup password 44 of the computer system 10, which should not be available in systems other than the server 11 and the computer system 10. The results of this comparison are saved to report to the calling routine, and in step 146, the subroutine 128 returns to the calling program, the initialization routine 96.

Referring again to FIG. 6, in step 150, the comparison results are obtained from the comparison made in step 144. If the two versions of the message digest match, the subroutine 96 proceeds from step 152 to step 153, in which the update of the protected partition 38 is authorized. If the two versions of the message digest do not match, the system proceeds from step 152 to step 154, in which the writing of the entry 62 to the protected partition 38 is not authorized.

If the update is authorized in step 153, the start location of the protected partition 38 is read in step 56 from the partition table in the master boot record of the hard drive 18. In step 158, this information is used to access the protected partition 38. In step 160, the header element 58 of the update partition file 56 (shown in FIG. 2) is accessed, with the pointer 66 to the first entry element being used in step 162 to find the first entry element in the file 56, or the next entry element in subsequent passes, after one or more entry elements have been addressed.

Each entry 62 in the update partition file 56 is intended either to replace information in a matching entry found within the protected partition 38 or, if there is no matching entry within the protected partition 38, to be added to the partition 38 as a new entry. Therefore, in step 164, the protected partition 38 is traversed to find a matching entry. If a matching entry is found, the initialization routine 36 proceeds from step 168 to step 170, in which the entry element of the matching entry is checked to determine the size of the matching entry. If the matching entry is the same size or larger than the new entry 62 from the update partition file 56, the routine 36 proceeds from step 172 to step 174, in which the old entry in the protected partition 38 is replaced with the new entry 62. On the other hand, if the matching entry in the protected partition 38 is smaller than the new entry 62, a determination is made in step 176 of whether there is sufficient room to expand the entry. If there is sufficient room, the routine 36 proceeds from step 180, in which the new entry 62 is copied into the protected partition 38, the header element within the partition 38 is adjusted to reflect the presence of the new entry, and other affected elements are adjusted as required.

On the other hand, if a matching entry is not found in step 168, it is known that the entry 62 is to be added, so the header element within the protected partition 38 is checked in step 182 to determine if there is sufficient room to add the new entry 62. If there is sufficient room, the initialization routine proceeds from step 184 to step 186, in which the new entry 62, together with its entry element 60, is written to the protected partition 38. Then, in step 188, the header element and any affected entry element of the protected partition 38 are adjusted to reflect the addition of information.

After a new entry 62 is written to the protected partition 38 in step 174, step 180, or step 188, the initialization routine 36 proceeds to step 190, in which a determination is made of whether there are one or more additional entries 62 to be processed within the update partition file 56. If writing the entry to the protected partition 38 is not authorized in step 154, or if it is determined in step 178 or step 184 that the new entry or update cannot be written to the partition 38 because there is insufficient space, an error message is displayed to the user in step 192, indicating that an update has been attempted, but that it has not occurred. Thus, while the process of updating the protected partition 38 can be carried on without the user's knowledge when the process is successful, a failure of the process is reported to the user, so that he can take corrective action if needed.

If it is determined in step 190 that there are more entries 62 in the update partition file 56, the initialization program 36 proceeds to step 126, in which the AUTHENTICATE subroutine 128 is called to determine the authenticity of the next entry 62 by means of the digital signature 64 associated with it. Thus, the various steps described above are repeated until each entry 62 in the file 56 has been processed. Then, when it is determined in step 190 that there are no more entries 62 to be processed, the initialization routine 36 proceeds to step 193, in which the flag is reset, indicating that there is no longer an update file stored for subsequent modification of the protected partition 38.

From step 193, the initialization routine 36 proceeds to step 194, in which more POST or diagnostic operations occur. Furthermore, when it is determined in step 124 that the flag has not been set, the routine 36 proceeds to step 194 to continue POST or diagnostic operations. Then, in step 196, a determination is made of whether the user has previously entered the setup password, providing a proper indication that he wants to update information in the protected partition 38. If he has not entered this password correctly, the routine 36 proceeds to step 198, in which this partition 38 is locked, so that data cannot be entered within it. Then, in step 200, POST or diagnostic operations are continued, and the operating system 40 is booted.

If it is determined in step 196 that the setup password has been entered correctly, the protected partition 38 is not locked, so that the system user can provide data to change the contents of the partition 38. This may be accomplished by making changes directly within the partition 38 or by writing information to a partition update file 56 stored within the hard drive 18 and subsequently handled as described before. In either case, the user is expected to restart the system, either manually or by responding with a selection to do so in a setup menu, before the changes take effect.

Since the method of the invention provides for verifying the identity of the server 11 transmitting the update partition file 56 to the computer system 10, such a transmission may alternately occur over a network 31, such as the Internet, using the public switched telephone network, with the transmission being made from a server 202 connected to the network 31. In this way, the invention can be used to provide data to computer systems 10 not connected to a LAN 34. For example, the manufacturer of the systems 10 could provide updated information in this manner.

Alternately, the update partition file 56 may be recorded on a removable computer readable medium 16 at the server 11, transported to the computer system 10, and read within the drive unit 14, being copied to the hard drive 18 to be used as described, or being read directly from the removable computer readable medium 16 to update the protected partition 38. In this case, the methods described above would verify that the data had been generated within the server 11, having knowledge of the setup password 44. The use of digital signatures 64 would further prevent the entry of data in the event that the medium 16 was altered after being recorded at the server 11.

The above description has indicated that the routine 86, as described in reference to FIG. 5, generating the update partition file is executed in the server 11. In another alternative version of the invention, this routine 86 executes within the computer system 10, with one or more entry elements 62 having been transmitted or transferred to the computer system 10 from the server 11, and with at least the setup password 44 being transmitted or transferred in an encrypted form so that it could be decrypted within the computer system 10 and used in the routine 86. For example, the setup password 44 could be encrypted within the server 11 using the public key of the computer system 10 and decrypted within the computer system 10 using its private key.

As described above, the preferred version of the invention provides redundant means for determining that the server 11 originated the update partition file 56. Matching the message digests in step 144 of the AUTHENTICATE subroutine 128 of FIG. 7 means that the file 56 comes from a system knowing the setup password 44 and from a system using the private key of the server 11 to form a digital signature. Since either of these conditions should be sufficient to indicate that the file 56 comes from the server 11, with some increase in the vulnerability of the process to allowing the use of falsified information, an alternative version of the invention does not use the setup password 44. In this alternative version, steps 90 and 94 of the routine 86 for generating the update partition file 56, as described in reference to FIG. 5, are omitted, with the message digest being formed in step 96 by applying the hash algorithm to the entry 62. Similarly, in the AUTHENTICATE subroutine 128, steps 132 and 136 are omitted, with the first version of the message digest being formed in step 138 by applying the hash algorithm to the entry 62.

In yet another version of the invention, the digital signature process is omitted, with reliance being placed upon knowledge of the setup password 44, again with some increase in the vulnerability of the process to falsified information. In this version, the digital signature 64 associated with each entry 62 is replaced by the setup password 44, encrypted using the public key of the computer system 10, so that it can be safely transmitted over the LAN 34 or over the network 31. Thus, in the routine 86 for generating the update partition file 56, steps 92, 94, and 96 are omitted, with the setup password accessed in step 90, instead of a digital signature, being encrypted with the public key of the computer system 10 and private key of the server 11 in place of step 98 In the AUTHENTICATE subroutine 128, steps 134, 136, 138, and 142 are then omitted, with the encrypted password from the update partition file 56 being decrypted with the private key of the computing system 10 in step 140 and public key 71 of the server 11 in place of step 142, to be compared, in step 144, with the password accessed from protected storage in step 132.

While the invention has been described in its performed versions with some degree of particularity, it is understood that this description has been given only by way of example, and that numerous changes in details, including the combination and rearrangement of process steps may be made without departing from the spirit and scope of the invention.

What is claimed is:

1. A method for updating a protected partition within a hard drive of a computing system, wherein said method comprises:
starting execution of an initialization program in a processor within said computing system in response to turning on electrical power within said computing system;
determining whether an update partition file is stored in non-volatile storage within said computing system for subsequently updating said protected partition;
after determining that said update partition is stored within said computing system for updating said protected partition, writing a portion of said update partition file to said protected partition; and
locking said protected partition to prevent further modification of information stored within said protected partition.

2. The method of claim 1, wherein
a flag bit is set in non-volatile storage within said computing system when said update partition file is stored in non-volatile storage within said computing system, and
determining whether said update partition is stored within said computing system for updating said protected partition is performed by determining whether said flag bit is set.

3. The method of claim 1, wherein
said method additionally comprises, after determining that said update partition file is stored within said computing system for updating said protected partition, verifying whether said update partition file has been generated by a trusted server system, and
said portion of said update partition is written to said protected partition only following verification that said update partition file has been generated by a trusted server system.

4. The method of claim 3, wherein verification that said update partition file has been generated by said trusted server system includes:
forming a first message digest by applying a hash algorithm to a portion of said update partition file;
forming a second message digest by decrypting a digital signature within said update partition file using a public key of said trusted server system; and;
determining that said first and second message digests are identical.

5. The method of claim 3, wherein
a setup password is stored in non-volatile storage within said computing system,
verifying that said update partition file has been generated by said trusted server system includes signing an encrypted portion of said update partition file with a public key of said trusted server system, and
said encrypted portion of said update partition file has been prepared by signing, with a private key of said trusted server system, a result of the application of an algorithm to data including a version of said setup password accessed by said trusted server system.

6. The method of claim 5, wherein
said data includes said version of said setup password appended to a portion of said update partition file,
said algorithm is a hash algorithm generating a message digest, and
verifying that said update partition file has been generated by said trusted server system includes applying said hash algorithm to said setup password stored within said computing system appended to a portion of said update partition file to generate a first version of a message digest and comparing said first version of said message digest with a second version of said message digest obtained by signing said encrypted portion of said update partition file.

7. The method of claim 1, wherein
said update partition file includes a plurality of entries and a plurality of encrypted elements,
each encrypted element within said plurality of encrypted elements is associated with an entry in said plurality of entries.
said method additionally comprises, following determining that said update partition file is stored within said computing system for updating said protected partition, verifying whether each entry in said plurality of entries within said update partition file has been generated by a trusted server system, and
each entry in said plurality of entries within said update partition is written to said protected partition only following verification that said entry has been generated by a trusted server system.

8. The method of claim 7, wherein verifying that said entry has been generated by said trusted server system includes:
forming a first message digest by applying a hash algorithm to said entry;
forming a second message digest by signing said encrypted element associated with said entry using a public key of said trusted server system; and;
determining that said first and second message digests are identical.

9. The method of claim 7, wherein
a setup password is stored in non-volatile storage within said computing system,
verifying that said entry has been generated by said trusted server system includes signing said encrypted element associated with said entry with a public key of said trusted server system, and
said encrypted element of said update partition file has been prepared by signing, with said private key of said trusted server system, a result of the application of an algorithm to data including a version of said setup password accessed by said trusted server system.

10. The method of claim 9, wherein
said data includes said version of said setup password appended to a said entry,
said algorithm is a hash algorithm generating a message digest, and
verifying that said entry has been generated by said trusted server system includes applying said hash algorithm to said setup password stored within said computing system appended said entry to generate a first version of a message digest and comparing said first version of said message digest with a second version of said message digest obtained by signing said encrypted element.

11. The method of claim 7, wherein
information stored in said protected partition is compared to each entry in said plurality of entries within said update partition,
when a matching portion of said information stored in said protected partition is found to be similar to said entry, said matching portion is overwritten with said entry if space around said matching portion is sufficient, and
when a matching portion of said information stored in said protected partition is not found to be similar to said entry, said entry is appended to said information stored in said protected partition if space within said protected partition is sufficient.

12. The method of claim 1, wherein
said method additionally comprises receiving an input signal from a keyboard of said computing system and comparing said input signal with a signal corresponding to a setup password stored in non-volatile storage within said computing system, and
said protected partition is left unlocked if said input signal matches said signal corresponding to said setup password.

13. A method for updating a protected partition within a hard drive of a client computing system, wherein said method comprises:
generating an update partition file within a server;
transferring said update partition file from said server to said client computing system;
storing said update partition file in non-volatile storage within said client computing system;
starting execution of an initialization program in a processor within said client computing system in response to turning on electrical power within said client computing system;
determining that said update partition file is stored in non-volatile storage within said client computing system;
writing a portion of said update partition file to said protected partition; and
locking said protected partition to prevent further modification of information stored within said protected partition.

14. The method of claim 13, wherein said update partition file is transferred from said server to said client computing system by means of electrical signals transmitted through a public switched telephone network.

15. The method of claim 13, wherein said update partition file is transferred from said server to said client computing system by means of electrical signals transmitted over a local area network.

16. The method of claim 13, wherein transferring said update partition file from said server to said client computing system includes:
writing said update partition file to a removable computer readable medium from said server;
transporting said removable computer readable medium from said sever to said client computing system; and
reading said update partition file from said removable computer readable medium into said client computing system.

17. The method of claim 13, wherein
a flag bit is set in non-volatile storage within said client computing system when said update partition file is stored in non-volatile storage within said client computing system, and
determining that said update partition file is stored in non-volatile storage within said client computing system includes determining that said flag bit is set.

18. The method of claim 13, wherein
said method additionally comprises, following a determination that said update partition file is stored within said client computing system for updating said protected partition, verifying within said client computer system that said update partition file has been generated by said server, and
said portion of said update partition is written to said protected partition only following verification that said update partition file has been generated by said server.

19. The method of claim 18, wherein:
generating said update partition file within said server includes forming a first message digest by applying a hash algorithm to a portion of said update partition file, signing said first message digest with a private key of said server to form a digital signature, and appending said digital signature to data within said update partition file; and
verifying within said client computing system that said update partition file has been generated by said server includes forming a second message digest by applying a hash algorithm to a portion of said update partition file, forming a third message digest by signing said digital signature within said update partition file using a public key of said server, and determining that said second and third message digests are identical.

20. The method of claim 18, wherein:
a setup password is stored in non-volatile storage within said client computing system;
a copy of said setup password is stored in a database accessible to said server;
generating said update partition file within said server includes forming an encrypted portion of said update partition file by signing a result of the application of an algorithm to data including said copy of said setup password; and
verifying within said client computing system that said update partition file has been generated by said server includes signing said encrypted portion of said update partition file with a public key of said server.

21. The method of claim 20, wherein
said data includes said version of said setup password appended to a portion of said update partition file,
said algorithm is a hash algorithm generating a message digest, and
verifying within said client computing system that said update partition file has been generated by said trusted server includes applying said hash algorithm to said setup password stored within said client computing system appended to a portion of said update partition file to generate a first version of a message digest and comparing said first version of said message digest with a second version of said message digest obtained by signing said encrypted portion of said update partition file with said public key of said server.

22. The method of claim 13, wherein
said update partition file includes a plurality of entries and a plurality of encrypted elements,
each encrypted element within said plurality of encrypted elements is associated with an entry in said plurality of entries.
said method additionally comprises, following a determination that said update partition file is stored within said client computing system for updating said protected partition, verifying within said client computing system whether each entry in said plurality of entries within said update partition file has been generated by a server, and
each entry in said plurality of entries within said update partition is written to said protected partition only following verification that said entry has been generated by said server.

23. The method of claim 22, wherein
each said encrypted element is formed in said server by applying a hash algorithm to said entry, forming a first message digest, and by signing said first message digest with a private key of said server; and
verification that said entry has been generated by said server includes forming a second message digest by applying a hash algorithm to said entry, forming a third message digest by signing said encrypted element associated with said entry using a public key of said server, and determining that said second and third message digests are identical.

24. The method of claim 22, wherein
a setup password is stored in non-volatile storage within said client computing system;
a copy of said setup password is stored in a database accessed by said server;
said encrypted element of said update partition file is prepared in said server by signing, with a private key of said server, a result of the application of an algorithm to data including said copy of said setup password; and
verification within said client computing system that said entry has been generated by said server includes signing said encrypted element associated with said entry with said public key of said server,

25. The method of claim 24, wherein
said data includes said version of said setup password appended to a said entry,
said algorithm is a hash algorithm generating a message digest, and
said verification that said entry has been generated by said server includes applying said hash algorithm to said setup password stored within said client computing system appended to said entry to generate a first version of a message digest and comparing said first version of said message digest with a second version of said message digest obtained by signing said encrypted element.

26. A computer system comprising:
a processor executing an initialization program in response to power being turned on in said computer program;
a hard drive having a protected partition blocked during execution of an initialization program to prevent changing information stored within said protected partition;
non-volatile storage storing an update partition data structure for modifying contents of said protected partition and said initialization program, wherein said initialization program executing within said processor determines that said update partition data structure is stored in said non-volatile storage, writes a portion of said update partition data structure to said protected partition, and locks said protected partition to prevent further modification of information stored within said protected partition.

27. The computer system of claim 26, wherein
a flag bit is set in non-volatile storage within said computing system when said update partition data structure is stored in non-volatile storage within said computing system, and
said initialization program determines said update partition is stored within said computing system for updating said protected partition is performed by determining that said flag bit is set.

28. The computer system of claim 26, wherein
after determining that said update partition data structure is stored within said computing system for updating said protected partition, said initialization program verifies whether said update partition data structure has been generated by a trusted server system, and
said portion of said update partition is written to said protected partition only following verification that said update partition data structure has been generated by a trusted server system.

29. The computer system of claim 28, wherein
said update partition data structure includes a plurality of entries and a plurality of encrypted elements,
each encrypted element within said plurality of encrypted elements is associated with an entry in said plurality of entries, and
said initialization program uses each said encrypted element to determine that an entry associated with said encrypted element has been generated by said trusted server system.

30. The computer system of claim 29, wherein
said non-volatile storage additionally stores a setup password, and
each said encrypted element includes a digital signature signed by said trusted server system, wherein said digital signature is formed by applying a hash algorithm to an entry associated with said encrypted element to form a message digest and by signing said message digest with a private key of said trusted server system.

31. A computer-readable medium, having stored thereon a data structure comprising a plurality of entries and a plurality of encrypted elements, wherein
each encrypted element within said plurality of encrypted elements is associated with an entry in said plurality of entries, and
each said encrypted element includes a digital signature signed by a trusted server system, wherein said digital signature is formed by applying a hash algorithm to an entry associated with said encrypted element, appended with a setup password of said computer system to form a message digest and by signing said message digest with a private key of said trusted server system.

32. A system for updating a protected partition within a hard drive of a remote computing system, wherein said system comprises:
a server including a database storing a setup password of said remote computer system and a public key of said remote computer system, and storage having stored thereon a data structure comprising a plurality of entries and a plurality of encrypted elements, wherein each encrypted element within said plurality of encrypted elements is associated with an entry in said plurality of entries, and each said encrypted element includes a digital signature signed by said server, wherein said digital signature is formed by applying a hash algorithm to an entry associated with said encrypted element to form a message digest and by signing said message digest with a private key of said server;
means for transferring said data structure from said server to said remote computing system;
a processor within said remote computer system;
non-volatile storage within said remote computer system storing an initialization program for execution within said processor in response to power being turned on within said remote computer system, wherein said initialization program executing within said processor determines that said update partition data structure is stored in said non-volatile storage, determines that each entry has been generated by said server, writes a portion of said entries to said protected partition, and locks said protected partition to prevent further modification of information stored within said protected partition.
